(19) United States
(12) Patent Application Publication
(10) Pub. No.: US 2006/0002703 A1
(43) Pub. Date: Jan. 5, 2006

(54) Toy camera set

(76) Inventor: Elliot Rudell, Torrance, CA (US)

Correspondence Address: IRELL & MANELLA LLP, 840 NEWPORT CENTER DRIVE, SUITE 400, NEWPORT BEACH, CA, 92660, US

(21) Appl. No.: 11/173,549

(22) Filed: Jul. 1, 2005

Related U.S. Application Data
(60) Provisional application No. 60/585,034, filed on Jul. 1, 2004.

(51) Int. Cl. G03B 15/00

(52) U.S. Cl. 396/661; 396/6

(57) ABSTRACT

A toy camera set. The camera set includes a camera that can be attached to a variety of different toy optical accessories. By way of example, the toy optical accessories may include a toy microscope, a toy periscope, or a toy binocular. The camera can be used to take a picture through the microscope, etc. The camera can be attached to one accessory and then attached to another accessory so that a single camera can be used with a number of toy optical devices.

### REFERENCE TO CROSS-RELATED APPLICATIONS

This application claims priority to provisional Application No. 60/585,034, filed on Jul. 1, 2004.

### BACKGROUND OF THE INVENTION

1. Field of the Invention

The present invention relates to a toy camera set.

2. Prior Art

There have been marketed various toy optical products such as toy microscopes and toy binoculars. To date there has not been a product that would allow a user to take a picture of the object being viewed through a toy microscope or a toy binocular or similar toy optical viewing device. It would be desirable to provide a product that would allow the user to take a picture of what is being viewed through, for example a toy microscope, so that the user can capture and review the object. It would be desirable if such a product were relatively inexpensive to produce and easy to use. It would be further desirable, as an educational activity system, for the iamging device to be readily adaptable to accept multiple special imaging components such as a telescope, or microscope or periscope.

### BRIEF SUMMARY OF THE INVENTION

A toy camera set that includes a camera and a toy optical accessory that can be attached to the camera.

### BRIEF DESCRIPTION OF THE DRAWINGS

FIG. 1 is a perspective view of a toy camera set;

FIG. 2 is a perspective view of a camera attached to a toy microscope of the set;

FIG. 3 is a perspective view of the camera attached to a toy binocular of the set;

FIG. 4 is a perspective view of the camera attached to a periscope of the set;

FIG. 5 is a perspective view of the camera attached to an underwater periscope of the set; and,

FIG. 6 is a perspective view of the camera being attached a toy accessory.

FIG. 7 is a perspective view of an alternate embodiment for attaching the camera to an accessory.

### DETAILED DESCRIPTION

Disclosed is a toy camera set. The camera set includes a camera that can be attached to a variety of different toy optical accessories. By way of example, the toy optical accessories may include a toy microscope, a toy periscope, or a toy binocular. The camera can be used to take a picture through the microscope, etc. The camera can be attached to one accessory and then attached to another accessory so that a single camera can be used with a number of toy optical devices.

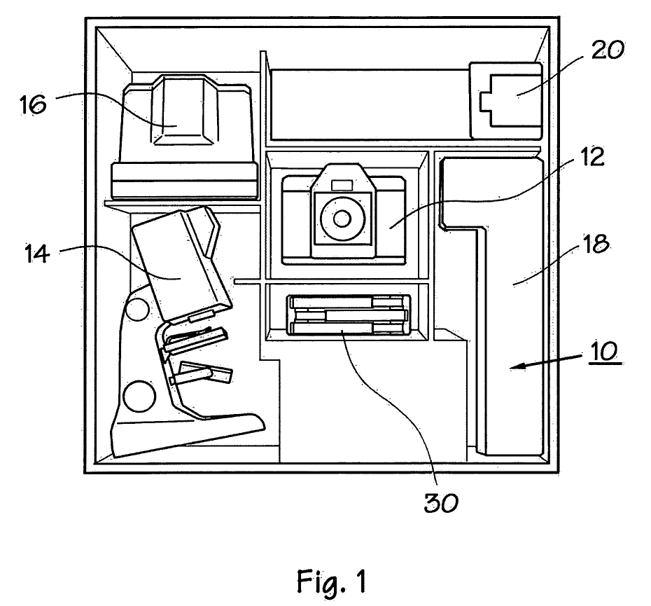

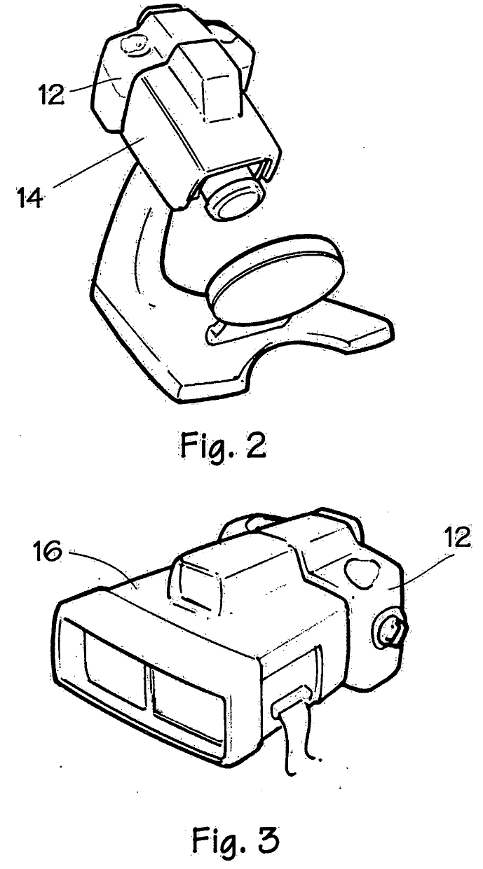

Referring to the drawings more particularly by reference numbers, FIG. 1 shows a toy camera set 10. The camera set 10 contains a camera 12 and a plurality of toy optical accessories 14, 16, 18 and 20. The toy optical accessories may include a toy microscope 14 that contains lenses and mirrors (not shown) that can magnify something located in the object field of the microscope 14. The camera 12 can be attached to the image field of the microscope 14 as shown in FIG. 2. The user can take a picture of a specimen with the camera 12. The housing of the toy microscope 14 is preferably constructed from a relatively lightweight and inexpensive plastic material, such as high impact styrene or abs plastic.

The camera 12 can be attached to a toy binocular 16 as shown in FIG. 3. The toy binocular 16 contains lenses, etc. used to magnify distant images. The housing of the toy binocular 16 is preferably constructed from a relatively lightweight and inexpensive plastic material. The camera 12 can be used to take pictures through the binoculars 16. The binoculars 16 can act as a lens for the camera 12.

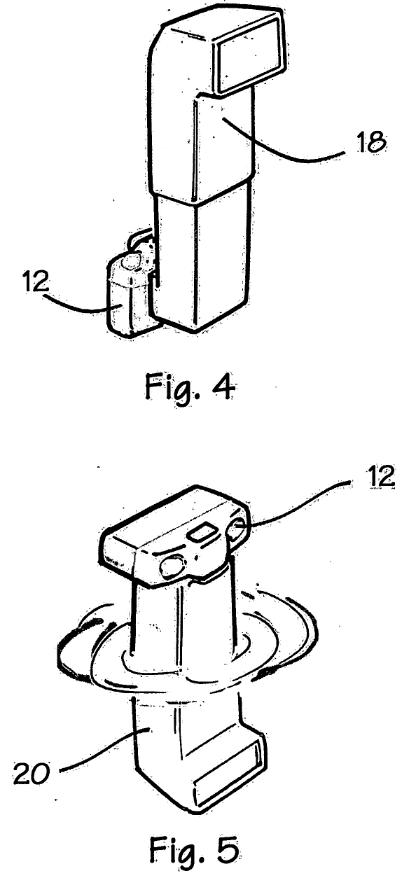

The camera 12 may also be attached to a periscope 18, or an underwater periscope 20, as shown in FIGS. 4 and 5, respectively. The periscopes 18 and 20 may contain lenses and mirrors enclosed by a plastic housing. The camera 12 can be used to take pictures thru the periscopes 18 and 20.

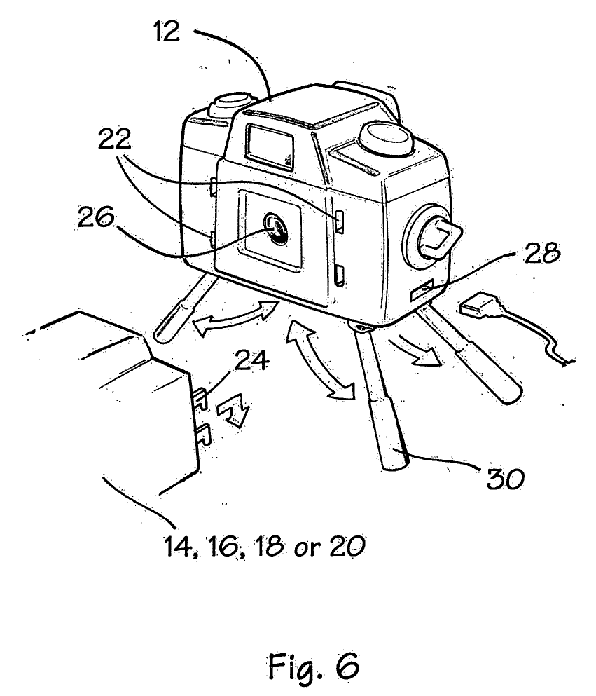

Key to the compatibility between the camera 12 and its accessories 14, 16, 18 and 20, is a coordinated attachment means to allow the child to easily attach and detach the accessories from the camera. As shown in FIG. 6 the camera 12 may have a pair of slots 22 that receives corresponding snap-on hooks 24 that extend from each toy accessory 14, 16, 18 and 20. The slots 22 and hooks 24 allow the camera 12 to be easily attached and detached from each accessory 14, 16, 18 and 20 without the use of any tools such as a screwdriver, etc., while assuring the necessary proper alignment between the camera 12 and said accessories.

The camera 12 is preferably of the digital type with a digital image sensor 26. Digital cameras typically have a connector 28 that can be connected to a personal computer or other such device so that the captured images can be downloaded to the computer. By way of example, the connector 28 may be of the USB type. The camera 12 may also have a detachable memory card (not shown) that can be plugged into a computer, etc. Digital cameras 12 have screens that allow the user to view the image that can be captured. Thus when the camera is attached to an optical accessory 14, 16, 18 and 20, the user can see the image viewed thru the accessory.

The camera 12 can be attached to a toy tripod 30. The toy tripod 30 may be three separate legs that are attached to the bottom of the camera 12. Alternatively, the tripod feature may be integral to the bottom of the camera 12, and thus non-removable from the camera 12.

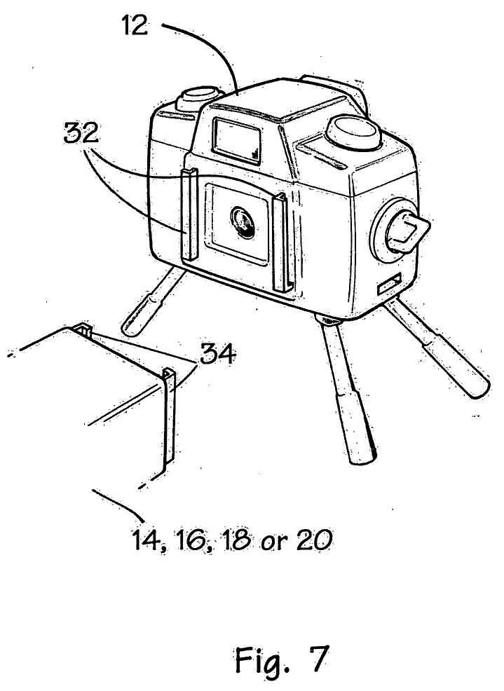

FIG. 7 is an alternate embodiment of a camera set that utilizes clips 32 and 34 to attach the camera 12 to an accessory 14, 16, 18, or 20. The clips 32 and 34 can be snapped together and subsequently pulled apart to attach and detach the camera 12. Although hooks 24 and clips 34 have been shown and described, it is to be understood that other attachment means such as magnets, buttons, VELCRO, etc. may be employed.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A toy camera set, comprising:
a camera; and,
a toy optical accessory that can be attached to and detached from said camera.

2. The toy camera set of claim 1, wherein said toy optical accessory is a toy microscope.

3. The toy camera set of claim 1, wherein said toy optical accessory is a toy binocular.

4. The toy camera set of claim 1, wherein said toy optical accessory is a toy periscope.

5. The toy camera set of claim 1, wherein said camera includes a pair of slots that receive a pair of snap on flanges of said toy optical accessory.

6. The toy camera set of claim 1, wherein said camera includes a digital image sensor.

7. A toy camera set, comprising:
a camera;
a toy microscope that can be attached to and detached from said camera;
a toy periscope that can be attached to and detached from said camera; and,
a toy binocular that can be attached to and detached from said camera.

8. The toy plane of claim 7, wherein said camera includes a digital image sensor.

9. A method for operating a toy camera set, comprising:
attaching a camera, in alignment with an image field of a toy optical accessory; and,
taking a picture of an object in said image field of the toy optical accessory.

10. The method of claim 9, wherein the toy optical accessory is a toy microscope.

11. The method of claim 9, wherein the toy optical accessory is a toy binocular.

12. The method set of claim 9, wherein the toy optical accessory is a toy periscope.
